(19) United States
(12) Patent Application Publication
(10) Pub. No.: US 2026/0255182 A1
(43) Pub. Date: Aug. 27, 2026

(54) TRANSMISSION APPARATUS, TRANSMISSION METHOD, RECEPTION APPARATUS, AND RECEPTION METHOD

(71) Applicant: SONY GROUP CORPORATION, TOKYO (JP)

(72) Inventor: MASANORI SATO, TOKYO (JP)

(21) Appl. No.: 19/161,368

(22) PCT Filed: Feb. 29, 2024
(86) PCT No.: PCT/JP2024/007490

§ 371 Date: Sep. 2, 2025

(30) Foreign Application Priority Data
Mar. 17, 2023 (JP) 2023-042714

(51) Int. Cl. H04W 16/28; H04L 1/08; H04W 84/06

(52) U.S. Cl. CPC H04W 16/28; H04L 1/08; H04W 84/06

(57) ABSTRACT

The present disclosure relates to a transmission apparatus, a transmission method, a reception apparatus, and a reception method that make it possible to reduce processing related to reception of identical signals transmitted by repeated transmission. A transmission controller performs repeated transmission to a reception apparatus included in a satellite, the reception apparatus receiving a signal by forming multiple beams, the repeated transmission being used to transmit an identical signal multiple times for a certain period of time; and a transmission interval determining section determines a transmission interval for the identical signals such that all of the identical signals are received over one of the multiple beams. The technology according to the present disclosure can be applied to a satellite communication system that uses a wireless technology for the IoT.

### TECHNICAL FIELD

The present disclosure relates to a transmission apparatus, a transmission method, a reception apparatus, and a reception method, and, in particular, to a transmission apparatus, a transmission method, a reception apparatus, and a reception method that make it possible to reduce processing related to reception of identical signals transmitted by repeated transmission.

### BACKGROUND ART

In a wireless technology for the Internet of Things (IoT), repeated transmission used to transmit an identical signal multiple times is performed in order to perform a long-distance communication. On the reception side, signals transmitted by repeated transmission are combined to improve a signal-to-noise ratio for the signal. This makes it possible to perform a long-distance communication.

For example, as an approach to improve a signal-to-noise ratio for a received signal, Patent Literature 1 discloses that, when information is carried by a radio signal, a one-minute super frame is set and an identical packet is transmitted ten times in the super frame.

### CITATION LIST

### Patent Literature

Patent Literature 1: WO 2017/212810

### DISCLOSURE OF INVENTION

### Technical Problem

When a satellite receiving station that receives a signal by forming a plurality of beams using a phased-array technology receives signals transmitted by repeated transmission, identical signals transmitted by performing transmission multiple times are received over different beams. On the reception side, it is necessary to perform processes on combining-target signals for a plurality of beams, and there is a problem in which processing related to reception gets complicated.

The present disclosure has been made in view of the circumstances described above, and it is an object of the present disclosure to make it possible to reduce processing related to reception of identical signals transmitted by repeated transmission.

### Solution to Problem

A transmission apparatus according to a first aspect of the present disclosure is a transmission apparatus that includes a transmission controller that performs repeated transmission to a reception apparatus included in a satellite, the reception apparatus receiving a signal by forming multiple beams, the repeated transmission being used to transmit an identical signal multiple times for a certain period of time; and a transmission interval determining section that determines a transmission interval for the identical signals such that all of the identical signals are received over one of the multiple beams.

A transmission method according to the first aspect of the present disclosure is a transmission method that is performed by a transmission apparatus, the transmission method including performing repeated transmission to a reception apparatus included in a satellite, the reception apparatus receiving a signal by forming multiple beams, the repeated transmission being used to transmit an identical signal multiple times for a certain period of time; and determining a transmission interval for the identical signals such that all of the identical signals are received over one of the multiple beams.

A reception apparatus according to a second aspect of the present disclosure is a reception apparatus that includes a reception controller that is included in a satellite, the reception controller receiving an identical signal by forming multiple beams, the identical signal being transmitted by a transmission apparatus multiple times for a certain period of time using repeated transmission; and a reception interval determining section that determines a reception interval for the identical signals such that all of the identical signals are received over one of the multiple beams.

A reception method according to the second aspect of the present disclosure is a reception method that is performed by a reception apparatus included in a satellite, the reception method including receiving an identical signal by forming multiple beams, the identical signal being transmitted by a transmission apparatus multiple times for a certain period of time using repeated transmission; and determining a reception interval for the identical signals such that all of the identical signals are received over one of the multiple beams.

In the first aspect of the present disclosure, repeated transmission to a reception apparatus included in a satellite is performed, the reception apparatus receiving a signal by forming multiple beams, the repeated transmission being used to transmit an identical signal multiple times for a certain period of time; and a transmission interval for the identical signals is determined such that all of the identical signals are received over one of the multiple beams.

In the second aspect of the present disclosure, an identical signal is received by forming multiple beams, the identical signal being transmitted by a transmission apparatus multiple times for a certain period of time using repeated transmission; and a reception interval for the identical signals is determined such that all of the identical signals are received over one of the multiple beams.

### BRIEF DESCRIPTION OF DRAWINGS

FIG. 1 illustrates an example of a configuration of a satellite communication system to which the technology according to the present disclosure can be applied.

FIG. 2 is a diagram used to describe a method for forming a beam using a satellite receiving station.

FIG. 3 is a diagram used to describe a change in a reception range for each beam that is caused due to movement of a satellite.

FIG. 4 is a block diagram of an example of a functional configuration of a transmission apparatus according to the present disclosure.

FIG. 5 is a flowchart used to describe how processing of determining a transmission interval is performed.

FIG. 6 illustrates examples of specific values of parameters.

FIG. 7 is a block diagram of an example of a functional configuration of a reception apparatus according to the present disclosure.

FIG. 8 is a flowchart used to describe how processing of determining a reception interval is performed.

### MODE(S) FOR CARRYING OUT THE INVENTION

Modes for carrying out the present disclosure (hereinafter referred to as embodiments) will be described below. Note that the description is made in the following order.
1. Background Technology and Issues
2. Example of Configuration of Satellite Communication System
3. Method for Forming Beam
4. Change in Reception Range for Each Beam That is Caused Due to Movement of Satellite
5. Configuration and Operation of Transmission Apparatus According to Present Disclosure
6. Configuration and Operation of Reception Apparatus According to Present Disclosure

### 1. BACKGROUND TECHNOLOGY AND ISSUES

### Background Technology

It is expected that the Internet of Things (IoT) will make it possible to acquire information from sensor terminals placed in mountainous regions or on the sea, where it has been difficult in the past to acquire information from the mountainous region or from the sea. It is expected that observation based on the acquired information makes it possible to grasp an environmental change and to prevent a disaster from being caused. On the other hand, there is an issue about placement of reception stations. It is expected that the number of terminals is smaller in, for example, a mountainous region than in an urban area. Thus, it will cost a lot to place and operate a reception station for a smaller number of terminals. Further, it is difficult to even place reception stations, for example, on the sea.

Thus, a wireless system using a satellite receiving station obtained by primarily including a reception station in a low-earth orbit satellite is under discussion. Due to the appearance of wireless technologies for the IoT that make it possible to perform a long-distance communication and due to a reduction in costs for launching small satellites, the construction of such a wireless system has been made more realistic. The construction of a wireless system obtained by using a ground-receiving station and a satellite receiving station in combination makes it possible to acquire information at low costs from any places on the earth.

A satellite orbit of a low-earth orbit satellite is at an altitude of about 400 km. Thus, a reception-target range is greatly wide when a normal reception antenna is used. Thus, a lot of interference waves other than a desired wave are also received. This may result in a reduction in a signal-to-noise ratio (an S/N ratio) of a received signal and thus in difficulty in communication.

Narrowing of a beam width of a reception antenna is conceivable as an approach to reduce received interference waves. As an approach to control the beam width of a reception antenna, there is a technology called a phased array. The phased array is a technology that makes it possible to narrow beam widths of a plurality of reception antennas by performing digital processing on signals received using the plurality of reception antennas, and can be a versatile technology for a satellite having size constraints. Further, a peak of a beam can be formed in any directions by changing the digital processing, and a wider range can also be set to be a reception target by combining a plurality of beams.

### Issues

In a wireless technology for the IoT, repeated transmission used to transmit an identical signal multiple times is performed in order to perform a long-distance communication. On the reception side, signals transmitted by repeated transmission are combined to improve a signal-to-noise ratio for the signal. This makes it possible to perform a long-distance communication.

For example, as an approach to improve a signal-to-noise ratio for a received signal, Patent Literature 1 discloses that, when information is carried by a radio signal, a one-minute super frame is set and an identical packet is transmitted ten times in the super frame.

When a satellite receiving station that receives a signal by forming a plurality of beams using a phased-array technology receives signals transmitted by repeated transmission, identical signals transmitted by performing transmission multiple times are received over different beams. On the reception side, it is necessary to perform processes on combining-target signals for a plurality of beams, and there is a problem in which processing related to reception gets complicated.

On the other hand, the technology according to the present disclosure makes it possible to reduce processing related to reception of identical signals transmitted by repeated transmission.

### 2. EXAMPLE OF CONFIGURATION OF SATELLITE COMMUNICATION SYSTEM

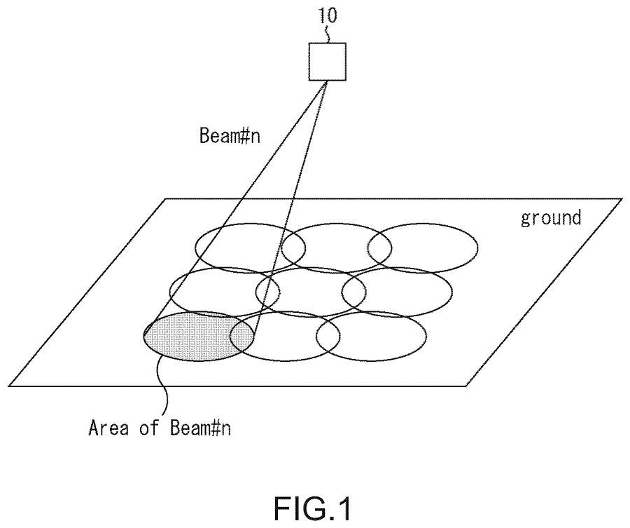

FIG. 1 illustrates an example of a configuration of a satellite communication system to which the technology according to the present disclosure can be applied.

In the satellite communication system illustrated in FIG. 1, a low-earth orbit satellite 10 orbits at, for example, an altitude of 400 km. The low-earth orbit satellite 10 includes a satellite receiving station (a reception apparatus) (not illustrated), and receives radio signals transmitted by a terrestrial terminal (not illustrated) placed on the ground.

The satellite receiving station forms a plurality of reception beams (a range in which reception can be performed) on the ground, and takes charge of regions of beams having different centers. Accordingly, a wide reception range is formed. In the example illustrated in FIG. 1, nine beams are formed to form a reception range including regions respectively indicated by nine circles.

### 3. METHOD FOR FORMING BEAM

In general, beams are formed using a technology called a phased array.

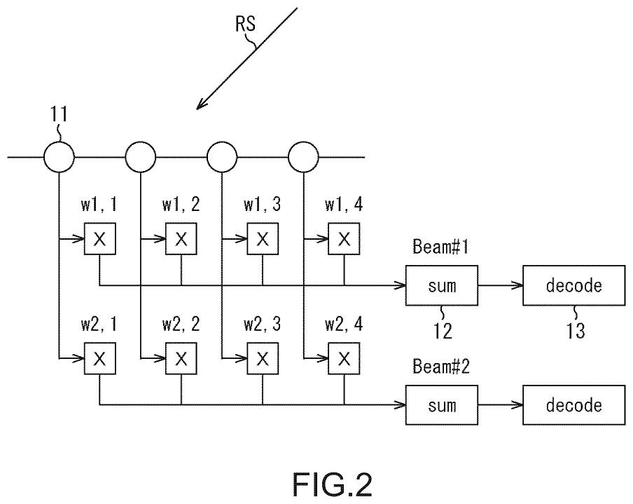

FIG. 2 is a diagram used to describe a method for forming a beam using a satellite receiving station. FIG. 2 illustrates an example of forming two beams.

In the phased array, a weight W is assigned to each of received signals RS respectively received by a plurality of nondirectional antennas 11 at a specific angle, and the received signals RS are summed by a summing section 12 to form beams. The received signal RS received over each beam is processed by a demodulator 13.

The change in the weight w assigned to the received signal RS makes it possible to increase a reception-antenna gain in a specific direction, that is, to control an orientation of a beam. Thus, the change in weight w also makes it possible to form different beams.

### 4. CHANGE IN RECEPTION RANGE FOR EACH BEAM THAT IS CAUSED DUE TO MOVEMENT OF SATELLITE

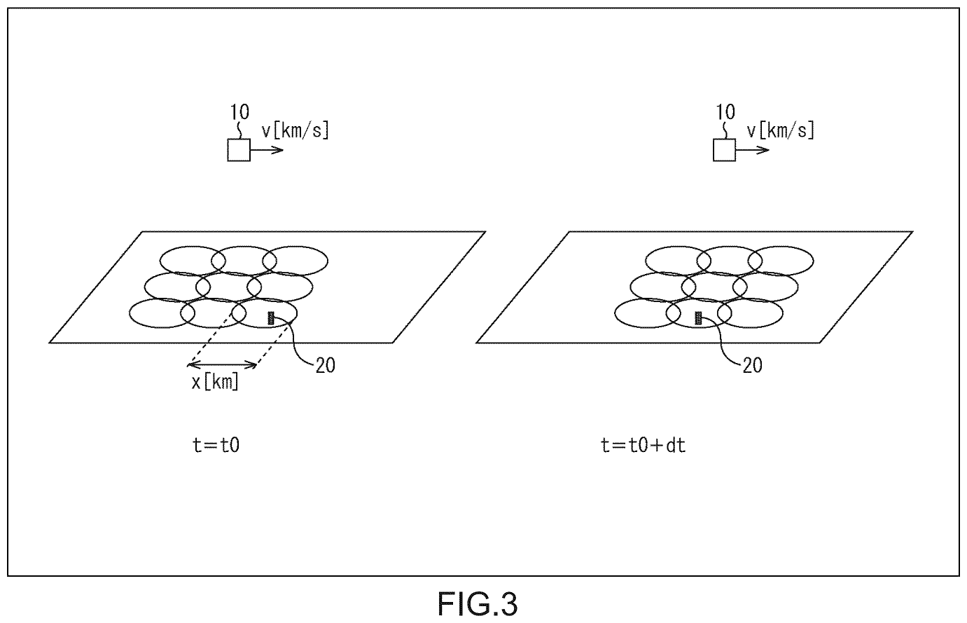

A change in a reception range for each beam that is caused due to movement of a satellite is described with reference to FIG. 3.

As illustrated in FIG. 3, the low-earth orbit satellite 10 moves at a movement speed v [km/s] in order to maintain its altitude. In the case of, for example, an altitude of 400 km, the low-earth orbit satellite 10 moves at a very high speed represented by v=7.9 [km/s].

In FIG. 3, the number of beams of reception antennas is nine, where a reception range, on the ground, that corresponds to each beam is indicated using a circle and a diameter of the circle is represented by x [km]. A terrestrial terminal 20 that includes a transmission apparatus is placed on the ground. The terrestrial terminal 20 performs repeated transmission in a cycle dt [sec].

In FIG. 3, the terrestrial terminal 20 performs a first-time transmission at a time t=t0, and performs a second-time transmission at a time t=t0+dt. In this case, the low-earth orbit satellite 10 receives signals over different beams in the first-time transmission and the second-time transmission.

When identical signals transmitted by repeated transmission are received over a plurality of beams, as described above, the signals are respectively processed by the demodulators 13 different from each other, as described with reference to FIG. 2. When received frames of a plurality of received frames are combined to be processed, there is a need to perform combing processing on the basis of outputs from the different demodulators. When transmission is performed three times or more by repeated transmission, there is a need to collect outputs from a larger number of demodulators 13 to perform the combining processing. This results in an increase in process volume related to the combining processing and thus in difficulty in reception processing performed by a satellite having constraints on processing capability and an increase in temperature.

### 5. CONFIGURATION AND OPERATION OF TRANSMISSION APPARATUS ACCORDING TO PRESENT DISCLOSURE

In a transmission apparatus according to the present disclosure, a transmission interval for identical signals transmitted by repeated transmission is determined such that all of the identical signals are received over one of multiple beams. This results in a reduction in processing related to reception of identical signals transmitted by repeated transmission.

### (Configuration of Transmission Apparatus)

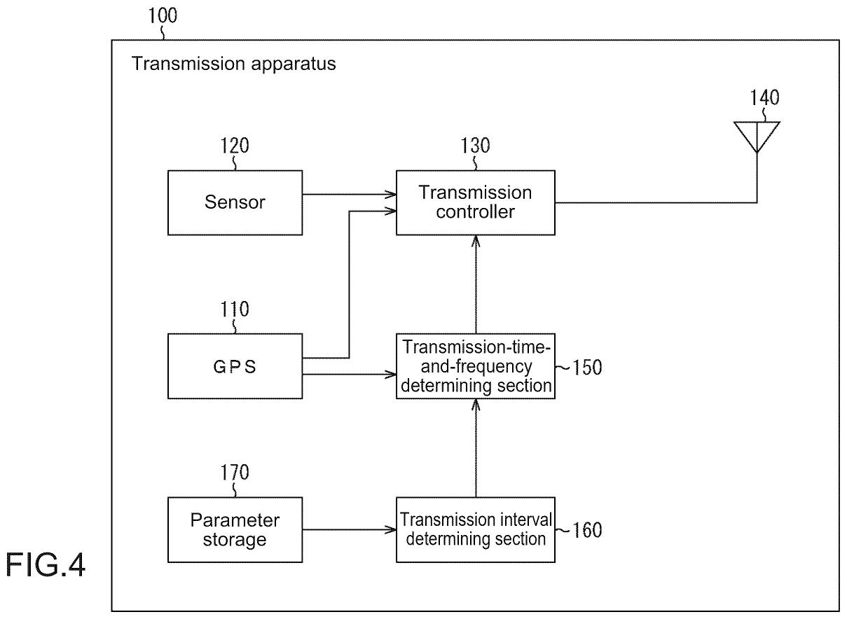

FIG. 4 is a block diagram of an example of a functional configuration of the transmission apparatus according to the present disclosure.

A transmission apparatus 100 illustrated in FIG. 4 can be the terrestrial terminal 20 described above. The transmission apparatus 100 includes a GPS receiver 110, a sensor 120, a transmission controller 130, a transmission antenna 140, a transmission-time-and-frequency determining section 150, a transmission interval determining section 160, and a parameter storage 170.

Through an antenna (not illustrated), the Global-Positioning-System (GPS) receiver 110 acquires a GPS signal transmitted by a GPS satellite. The GPS receiver 110 supplies the transmission controller 130 and the transmission-time-and-frequency determining section 150 with position information and time information that are included in the GPS signal.

The sensor 120 includes various sensors that perform, for example, detection or measurement on a discretionary variable or an amount of a change in the variable, where examples of the discretionary variable include variables for an image, light, brightness, saturation, electricity, sound, oscillation, acceleration, a speed, an angular velocity, a force, a temperature (not a temperature distribution), humidity, a distance, the area, the volume, a shape, a flow rate, time, a period of time, magnetism, a chemical substance, and scent. Sensor data output by the sensor 120 is supplied to the transmission controller 130 as transmission data destined for the low-earth orbit satellite 10.

The transmission controller 130 modulates, into a transmission signal, the transmission data (the sensor data) from the sensor 120 and position information from the GPS receiver 110, and converts the transmission signal into a transmission frequency.

Here, the transmission controller 130 performs, for example, binary-phase-shift-keying (BPSK) modulation on transmission data, and performs chirp modulation on the transmission data on which the BPSK modulation has been performed. It is sufficient if the chirp modulation is performed to generate a transmission signal of a channel also known to the reception side. Further, the transmission controller 130 converts a transmission signal obtained by the chirp modulation into a transmission frequency.

Then, the transmission controller 130 amplifies the transmission signal converted into the transmission frequency, and transmits the transmission signal to the above-described low-earth orbit satellite 10 through the transmission antenna 140 as a radio signal.

Further, the transmission controller 130 performs repeated transmission to a reception apparatus included in the low-earth orbit satellite 10, the reception apparatus receiving a signal by forming multiple beams, the repeated transmission being used to transmit an identical signal multiple times for a certain period of time.

The transmission-time-and-frequency determining section 150 determines a transmission time (a transmission timing) and a transmission frequency (a transmission channel) at which a radio signal is transmitted by the transmission controller 130. In the transmission apparatus 100, the transmission time and transmission frequency at which a radio signal is transmitted are set on the basis of identification information regarding the transmission apparatus 100 itself, and a time. For example, the transmission-time-and-frequency determining section 150 obtains the transmission time and the transmission frequency on the basis of identification information stored in a memory (not illustrated) that is included in the transmission apparatus 100, and on the basis of a time indicated by time information supplied by the GPS receiver 110.

The transmission interval determining section 160 determines a transmission interval for identical signals transmitted by repeated transmission used to transmit an identical signal multiple times for a certain period of time, such that all of the identical signals are received over one of multiple beams formed by the reception apparatus.

Specifically, the transmission interval determining section 160 determines the transmission interval for identical signals transmitted by repeated transmission, on the basis of the movement speed of the low-earth orbit satellite 10, a reception range for each beam formed by the low-earth orbit satellite 10 (the reception apparatus), and the number of times of transmission in the repeated transmission.

The parameter storage 170 is a storage region included in the terrestrial terminal 20, and stores therein, as parameters, the movement speed of the low-earth orbit satellite 10, the reception range for each beam formed by the low-earth orbit satellite 10 (the reception apparatus), and the number of times of transmission in repeated transmission.

It is assumed that the reception range (hereinafter also referred to as a beam width) for each beam formed by the low-earth orbit satellite 10 (the reception apparatus) is determined at a timing at which the satellite communication system is constructed. Further, the beam width, the movement speed of the low-earth orbit satellite 10, and the number of times of transmission in repeated transmission are written into the parameter storage 170 in advance.

In other words, the transmission interval determining section 160 determines the transmission interval for identical signals transmitted by repeated transmission, on the basis of the parameters stored in the parameter storage 170.

This enables the transmission controller 130 to perform repeated transmission to the low-earth orbit satellite 10 (the reception apparatus) at the transmission interval determined by the transmission interval determining section 160 at the transmission time and transmission frequency determined by the transmission-time-and-frequency determining section 150.

### (Operation of Transmission Apparatus)

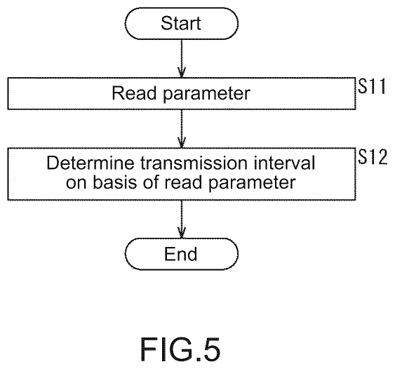

How processing of determining a transmission interval in consideration of beam width is performed, is described with reference to a flowchart in FIG. 5.

In Step S11, the transmission interval determining section 160 reads, as parameters stored in the parameter storage 170, the beam width x [km], the movement speed v [km/s] of the low-earth orbit satellite 10, and the number of times N [number of times] of transmission in the repeated transmission.

In Step S12, the transmission interval determining section 160 determines a transmission interval on the basis of the read parameters. Specifically, the transmission interval determining section 160 determines the transmission interval dt [sec] such that Formula (1) indicated below is satisfied, in order for repeated transmission to be performed in a reception range for a single beam.

$$\begin{matrix}[ Math . 1 ] & \\ dt < \frac{X}{v N} & ( 1 )\end{matrix}$$

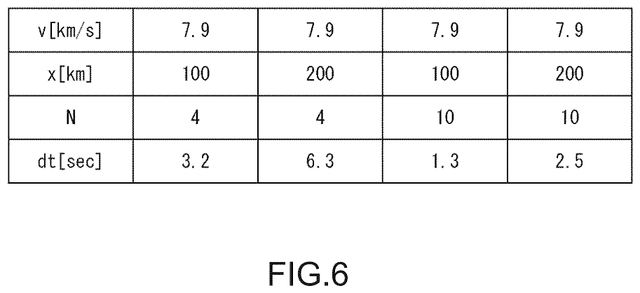

FIG. 6 illustrates examples of specific values of parameters.

FIG. 6 illustrates upper limits of the transmission interval dt [sec] when the beam width x [km] and the number of times N [number of times] of transmission are changed, with the movement speed of the low-earth orbit satellite 10 being fixed such that v=7.9 [km/s].

The upper limit of the transmission interval dt is 3.2 [sec] when the beam width x=100 [km] and the number of times of transmission N=4 [number of times], and the upper limit of the transmission interval dt is 6.3 [sec] when the beam width x=200 [km] and the number of times of transmission N=4 [number of times]. Further, the upper limit of the transmission interval dt is 1.3 [sec] when the beam width x=100 [km] and the number of times of transmission N=10 [number of times], and the upper limit of the transmission interval dt is 2.5 [sec] when the beam width x=200 [km] and the number of times of transmission N=10 [number of times].

According to the processing described above, when the transmission apparatus 100 performs repeated transmission at a transmission interval less than an upper limit of the transmission interval dt that is determined as described above, this makes it possible to increase the possibility that all of the signals will be in a reception range for a single beam. This results in being able to reduce processing related to reception of identical signals transmitted by repeated transmission, where examples of the processing related to the reception include demodulation processing performed by the low-earth orbit satellite 10 having constraints on the computational capability and resources such as a power supply.

### Modifications

When the upper limit of the transmission interval dt is determined in accordance with Formula (1) in the above-described embodiment of the transmission apparatus 100, signals transmitted by repeated transmission may be in reception ranges for up to two beams, depending on a positional relationship between the low-earth orbit satellite 10 and the terrestrial terminal 20.

Thus, the transmission interval dt [sec] is determined such that Formula (2) indicated below is satisfied, using a coefficient α (α<1).

$$\begin{matrix}[ Math . 2 ] & \\ dt < \frac{α x}{v N} ( α < 1 ) & ( 2 )\end{matrix}$$

When the reception range for a beam is underestimated by the beam width x [km] being multiplied by the coefficient α, as described above, this makes it possible to further increase the possibility that all of the signals will be in a reception range for a single beam. This results in being able to reduce, with more certainty, processing related to reception of identical signals transmitted by repeated transmission.

### 6. CONFIGURATION AND OPERATION OF RECEPTION APPARATUS ACCORDING TO PRESENT DISCLOSURE

In a reception apparatus that receives an identical signal by forming multiple beams, the identical signal being transmitted by the above-described transmission apparatus 100 using repeated transmission, there is also a need to determine a reception interval for identical signals such that all of the identical signals are received over one of multiple beams.

### (Configuration of Reception Apparatus)

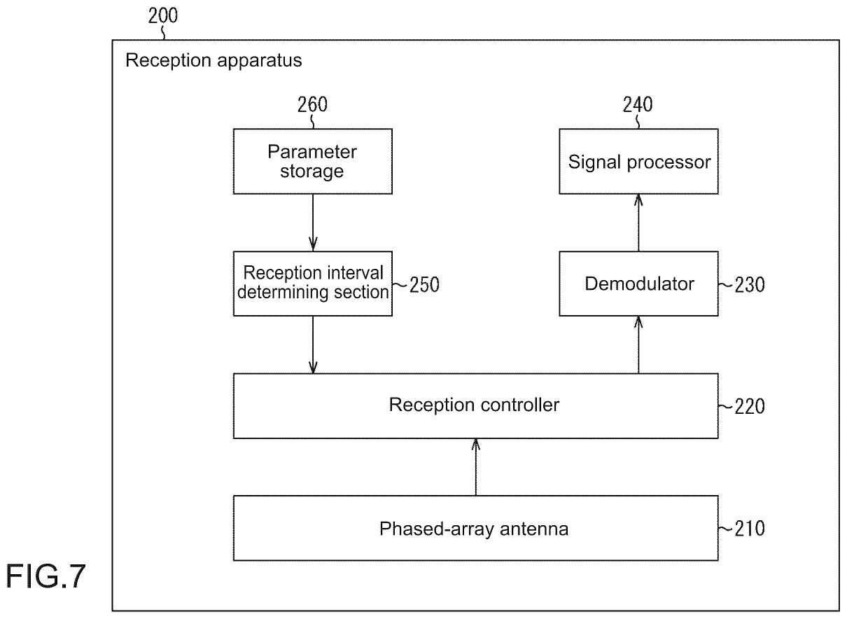

FIG. 7 is a block diagram of an example of a functional configuration of a reception apparatus according to the present disclosure.

A reception apparatus 200 illustrated in FIG. 7 can be included in the low-earth orbit satellite 10 described above. The reception apparatus 200 includes a phased-array antenna 210, a reception controller 220, a demodulator 230, a signal processor 240, a reception interval determining section 250, and a parameter storage 260.

The phased-array antenna 210 includes a plurality of arranged nondirectional antennas, and forms a plurality of beams on the ground by control being performed by the reception controller 220.

The reception controller 220 controls an orientation of each beam by changing a weight assigned to a received signal received over the beam, the beam being formed by the phased-array antenna 210. The received signal received over each beam is supplied to the demodulator 230.

Further, the reception controller 220 receives an identical signal by forming multiple beams, the identical signal transmitted by the terrestrial terminal 20 (the transmission apparatus 100) multiple times for a certain period of time using repeated transmission.

The demodulator 230 demodulates, for each beam, a received signal of each beam that is supplied by the reception controller 220, and supplies the demodulated signal to the signal processor 240. Here, in response to a transmission signal being modulated by the transmission apparatus 100, the received signal is dechirped, and BPSK demodulation is performed on the dechirped received signal.

The signal processor 240 performs specified signal processing on a received signal of each beam that is demodulated by the demodulator 230, and outputs the signal to, for example, a computation section (not illustrated) situated on the output side.

The reception interval determining section 250 determines a reception interval for identical signals transmitted by the transmission apparatus 100 using repeated transmission, such that all of the identical signals transmitted by repeated transmission are received over one of multiple beams formed by the reception apparatus 200.

Specifically, the reception interval determining section 250 determines a reception interval for identical signals transmitted by repeated transmission, on the basis of the movement speed of the low-earth orbit satellite 10, the reception range (the beam width) for each beam formed by the low-earth orbit satellite 10 (the reception apparatus 200), and the number of times of transmission in the repeated transmission.

The parameter storage 260 stores therein, as parameters, the movement speed of the low-earth orbit satellite 10, the beam width, and the number of times of transmission in repeated transmission. The movement speed of the low-earth orbit satellite 10, the beam width, and the number of times of transmission in repeated transmission are written into the parameter storage 260 in advance.

In other words, the reception interval determining section 250 determines the reception interval for identical signals transmitted by repeated transmission, on the basis of the parameters stored in the parameter storage 260.

This enables the reception controller 220 to receive, at a reception interval determined by the reception interval determining section 250, an identical signal transmitted multiple times for a certain period of time using repeated transmission.

### (Operation of Reception Apparatus)

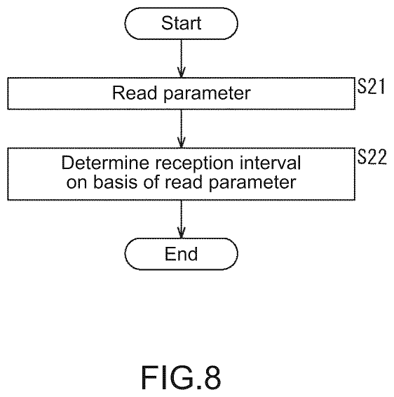

How processing of determining a reception interval in consideration of beam width is performed, is described with reference to a flowchart in FIG. 8.

In Step S21, the reception interval determining section 250 reads, as parameters stored in the parameter storage 260, the beam width x [km], the movement speed v [km/s] of the low-earth orbit satellite 10, and the number of times N [number of times] of transmission in the repeated transmission.

In Step S22, the reception interval determining section 250 determines a reception interval on the basis of the read parameters. Specifically, the reception interval determining section 250 determines a reception interval (an upper limit) as in the case of Formula (1) described above, in order for repeated transmission to be performed in a reception range for a single beam.

According to the processing described above, when the reception apparatus 200 receives, at a reception interval determined as described above, signals transmitted by repeated transmission, this makes it possible to increase the possibility that all of the signals will be in a reception range for a single beam. This results in being able to reduce processing related to reception of identical signals transmitted by repeated transmission, where examples of the processing related to the reception include demodulation processing performed by the low-earth orbit satellite 10 having constraints on the computational capability and resources such as a power supply.

Further, when the upper limit of the reception interval is determined on the basis of Formula (1) in the above-described embodiment of the reception apparatus 200, signals transmitted by repeated transmission may be in reception ranges for up to two beams, depending on a positional relationship between the low-earth orbit satellite 10 and the terrestrial terminal 20.

Thus, the reception interval may be determined on the basis of Formula (2) described above, using the coefficient α (α<1).

When the reception range for a beam is underestimated as described above, this makes it possible to further increase the possibility that all of the signals will be in a reception range for a single beam. This results in being able to reduce, with more certainty, processing related to reception of identical signals transmitted by repeated transmission.

The embodiment of the present disclosure is not limited to the embodiments described above, and various modifications may be made thereto without departing from the scope of the present disclosure.

Further, the effects described herein are not limitative but are merely illustrative, and other effects may be provided.

Furthermore, the present disclosure may take the following configuration.
(1) A transmission apparatus, including:
   a transmission controller that performs repeated transmission to a reception apparatus included in a satellite, the reception apparatus receiving a signal by forming multiple beams, the repeated transmission being used to transmit an identical signal multiple times for a certain period of time; and
   a transmission interval determining section that determines a transmission interval for the identical signals such that all of the identical signals are received over one of the multiple beams.
(2) The transmission apparatus according to (1), in which
   the transmission interval determining section determines the transmission interval on the basis of a movement speed of the satellite, a reception range for each of the beams, and the number of times of transmission in the repeated transmission.
(3) The transmission apparatus according to (2), further including
   a storage that stores therein, as parameters, the movement speed, the reception range, and the number of times of transmission, in which
   the transmission interval determination section determines the transmission interval on the basis of the stored parameters.
(4) The transmission apparatus according to (3), in which
   the transmission interval determination section determines the transmission interval such that the transmission interval has a value smaller than a value obtained by the reception range being divided by a product of the movement speed and the number of times of transmission.
(5) The transmission apparatus according to (3), in which
   the transmission interval determination section determines the transmission interval such that the transmission interval has a value smaller than a value obtained by a product of a coefficient α (α<1) and the reception range being divided by a product of the movement speed and the number of times of transmission.
(6) A transmission method that is performed by a transmission apparatus, the transmission method including:
   performing repeated transmission to a reception apparatus included in a satellite, the reception apparatus receiving a signal by forming multiple beams, the repeated transmission being used to transmit an identical signal multiple times for a certain period of time; and
   determining a transmission interval for the identical signals such that all of the identical signals are received over one of the multiple beams.
(7) A reception apparatus, including:
   a reception controller that is included in a satellite, the reception controller receiving an identical signal by forming multiple beams, the identical signal being transmitted by a transmission apparatus multiple times for a certain period of time using repeated transmission; and
   a reception interval determining section that determines a reception interval for the identical signals such that all of the identical signals are received over one of the multiple beams.
(8) The reception apparatus according to (7), in which
   the reception interval determining section determines the reception interval on the basis of a movement speed of the satellite, a reception range for each of the beams, and the number of times of transmission in the repeated transmission.
(9) The reception apparatus according to (8), further including
   a storage that stores therein, as parameters, the movement speed, the reception range, and the number of times of transmission, in which
   the reception interval determination section determines the reception interval on the basis of the stored parameters.
(10) The reception apparatus according to (9), in which
   the reception interval determination section determines the reception interval such that the reception interval has a value smaller than a value obtained by the reception range being divided by a product of the movement speed and the number of times of transmission.
(11) The reception apparatus according to (9), in which
   the reception interval determination section determines the reception interval such that the reception interval has a value smaller than a value obtained by a product of a coefficient α (α<1) and the reception range being divided by a product of the movement speed and the number of times of transmission.
(12) A reception method that is performed by a reception apparatus included in a satellite, the reception method including:
   receiving an identical signal by forming multiple beams, the identical signal being transmitted by a transmission apparatus multiple times for a certain period of time using repeated transmission; and
   determining a reception interval for the identical signals such that all of the identical signals are received over one of the multiple beams.

### REFERENCE SIGNS LIST

10 low-earth orbit satellite
20 terrestrial terminal
100 transmission apparatus
130 transmission controller
160 transmission interval determining section
170 parameter storage
200 reception apparatus
250 reception interval determining section
260 parameter storage

1. A transmission apparatus, comprising:
a transmission controller that performs repeated transmission to a reception apparatus included in a satellite, the reception apparatus receiving a signal by forming multiple beams, the repeated transmission being used to transmit an identical signal multiple times for a certain period of time; and
a transmission interval determining section that determines a transmission interval for the identical signals such that all of the identical signals are received over one of the multiple beams.

2. The transmission apparatus according to claim 1, wherein
the transmission interval determining section determines the transmission interval on a basis of a movement speed of the satellite, a reception range for each of the beams, and the number of times of transmission in the repeated transmission.

3. The transmission apparatus according to claim 2, further comprising
a storage that stores therein, as parameters, the movement speed, the reception range, and the number of times of transmission, wherein
the transmission interval determination section determines the transmission interval on a basis of the stored parameters.

4. The transmission apparatus according to claim 3, wherein
the transmission interval determination section determines the transmission interval such that the transmission interval has a value smaller than a value obtained by the reception range being divided by a product of the movement speed and the number of times of transmission.

5. The transmission apparatus according to claim 3, wherein
the transmission interval determination section determines the transmission interval such that the transmission interval has a value smaller than a value obtained by a product of a coefficient α (α<1) and the reception range being divided by a product of the movement speed and the number of times of transmission.

6. A transmission method that is performed by a transmission apparatus, the transmission method comprising:
performing repeated transmission to a reception apparatus included in a satellite, the reception apparatus receiving a signal by forming multiple beams, the repeated transmission being used to transmit an identical signal multiple times for a certain period of time; and
determining a transmission interval for the identical signals such that all of the identical signals are received over one of the multiple beams.

7. A reception apparatus, comprising:
a reception controller that is included in a satellite, the reception controller receiving an identical signal by forming multiple beams, the identical signal being transmitted by a transmission apparatus multiple times for a certain period of time using repeated transmission; and
a reception interval determining section that determines a reception interval for the identical signals such that all of the identical signals are received over one of the multiple beams.

8. A reception method that is performed by a reception apparatus included in a satellite, the reception method comprising:
receiving an identical signal by forming multiple beams, the identical signal being transmitted by a transmission apparatus multiple times for a certain period of time using repeated transmission; and
determining a reception interval for the identical signals such that all of the identical signals are received over one of the multiple beams.
